(19) United States
(12) Patent Application Publication
(10) Pub. No.: US 2004/0268339 A1
(43) Pub. Date: Dec. 30, 2004

(54) Firmware validation

(76) Inventors: Nicholas Benedict Van Someren, CAMBRIDGE (GB); Ian Nigel Harvey, Cambridge (GB)

Correspondence Address: MORGAN & FINNEGAN, L.L.P., 3 WORLD FINANCIAL CENTER, NEW YORK, NY, 10281-2101, US

(21) Appl. No.: 10/483,094

(22) PCT Filed: Jul. 4, 2002
(86) PCT No.: PCT/GB02/03058

(30) Foreign Application Priority Data
Jul. 6, 2001 (GB) 0116568.7

(51) Int. Cl. G06F 9/44

(52) U.S. Cl. 717/172; 717/170; 717/177

(57) ABSTRACT

A system for validating firmware, for example in an embedded computer system, includes means within the embedded system (10) for returning an authentication code in dependence upon the firmware (18) itself and the value of an external challenge. A user (24) receives the authentication code from the system (10) and checks it against a check authentication code created by an agent (28), computer algorithm or trusted third party who knows what firmware should be present. The user (24) accepts the firmware as valid if the response from the system (10) and the agent (28) agree. The firmware is compressed and the rest of the memory (14) filled with random data (36) to prevent an attacker storing spoofing code within the memory.

The present invention relates to firmware validation, and in particular although not exclusively to the validation of firmware within secure embedded computer systems.

A great many systems rely nowadays on embedded computer systems for their functionality, and those embedded systems in turn rely on their firmware (built in software) for their correct operation. In the vast majority of cases, the user simply operates the system with the firmware originally supplied by the manufacturer, upgrading later as necessary if any change to the functionality is required. The firmware version number, as reported by the firmware itself, is all that the user normally needs to know.

Such an approach is inadequate in the context of secure or sensitive systems such as for example Automated Teller Machines for banks, or Computer Security Modules for storing encryption keys. These and other secure applications needs to be resistant to the attentions of malicious attackers who might attempt to alter or replace the firmware code so that it carries out some modified function, thus breaching the security of the system.

One way in which the validity of the firmware can be checked is to read it out of the system and to compare it, byte by byte, with a reference copy that is known to be correct. While such an approach is effective, it may not be attractive to the supplier or manufacturer of the system, since it requires the entire contents of the firmware to be extracted from the secure embedded environment. Once extracted, the information passes out of the control of the manufacturer, and might easily fall into the hands of an attacker. Furthermore, the firmware itself may represent valuable intellectual property, and the manufacturer may well not want that disclosed to anybody at all, even to the purchaser or user of the embedded system.

In an effort to keep the firmware confidential, it has been proposed to add a function to the firmware which will cause it, on request, to compute a checksum (or fingerprint) on the whole of the firmware and return this to the user. Since only the fingerprint is divulged, the firmware and the intellectual property it represents can remain safely contained within the embedded system. The user checks the fingerprint against the known correct value, usually supplied by the manufacturer, and concludes that the firmware is valid if the two values are the same. This method works well against accidental corruption of the firmware, but does not prevent a malicious attacker altering the firmware and, at the same time, changing the fingerprint function so that the “correct” or expected value is always returned.

One approach to dealing with this problem is disclosed in WO-A-0018162. However, while the system disclosed in WO-A-0018162 may protect the user from a wide range of attacks, it could in principle be subverted were the attacker to be extremely technically adept. If the attacker could use data compression techniques to compress the original embedded software, it would then in principle at least be possible to keep both the compressed correct software and the attacker's modified software in memory. The usual operation of the system could then be replaced by the attacker's bogus operation, but when faced with a challenge, it could decompress the original software and compute the correct authentication code to return on the basis of that correct software.

It is an object of the present invention at least to alleviate this problem of the prior art.

According to a first aspect of the present invention there is provided a firmware validation system comprising:

(a) a computer system (10) containing firmware (18) to be validated, the computer system including authentication means (20;22) arranged to return an authentication code in dependence upon:

(i) a first input comprising an external challenge, and

(ii) a second input representative of the firmware (18);

(b) a trusted system (28) including check authentication means arranged to return a check authentication code in response to an external challenge; and

(c) means for issuing equivalent challenges to the computer system and the trusted system, and for determining that the firmware is valid if the resultant authentication code is equivalent to the check authentication code;

the system being characterised in that the firmware is held in persistent memory in compressed form, along with an uncompression routine and additional substantially incompressible data to fill the memory.

According to a further aspect of the invention there is provided a firmware validation system comprising:

(a) a computer system containing firmware to be validated, the computer system including authentication means arranged to return an authentication code in dependence upon:

(i) a first input comprising an external challenge, and

(ii) a second input representative of the firmware;

(b) a trusted system including check authentication means arranged to return a check authentication code in response to an external challenge; and

(c) means for supplying a code representative of the authentication code as a challenge to the trusted system, and for determining that the firmware is valid in dependence upon the resultant check authentication code;

and wherein the firmware is held in persistent memory in compressed form, along with an uncompression routine and additional substantially incompressible data to fill the memory.

The authentication means may comprise either a hardware authentication module, incorporated within the system, or alternatively a software function. Where the authentication means comprises a software function, that function may be stored in a common memory (for example a read only memory) with the firmware to be validated. In the present context, “read only memory” includes flash and other persistent memory technologies (which could be overwritten by an attacker) as well as memory modules and other replaceable memory technologies (which could simply be replaced with an illegitimate version).

The external challenge forming the first input to the authentication means may be remotely provided by a user of the system, and preferably takes the form of a random number chosen from within a wide range. This makes it impossible or at least unfeasible for an attacker to replicate the functionality of the authentication means by simply storing all possible responses to all possible challenges.

The second input to the authentication means is representative of the firmware to be validated. It is preferred that the input comprises the entirety of the firmware itself, although it would be possible for just a part of the firmware to be used, or alternatively the output of some function which is representative of the firmware. Also, it is envisaged that the second input may include additional data, other than the firmware itself, for example the entirety of the information stored in the memory (e.g. the ROM) which holds the firmware. In one embodiment, the memory holds a compressed copy of the firmware, plus an uncompression program, with random data filling the rest of the memory; in another embodiment the memory contains an encrypted copy of the firmware, a decryption program, and again random data filling the rest of the memory. In both of those embodiments, preferably the entirety of the stored information, including the random data, is used as the second input to the authentication means.

The computer system is preferably an embedded system, and may also or alternatively be a secure system which includes means for preventing or resisting extraction or copying of the firmware. In one specific embodiment, a computer system comprises a computer security module for the storage of secure data, for example for the management and storage of cryptographic keys.

Where equivalent challenges are issued to the computer system and to the trusted system, those challenges may, but need not, be absolutely identical. It might be desirable for the challenges to be different, but essentially mathematically equivalent, if for example there were a need for one challenge to be encrypted to a first key and the other to be encrypted to a second key. The operative result is of course what is important, and not whether the two challenges are absolutely identical.

Likewise, dependent upon the algorithms used, it is preferable but by no means essential for the authentication code to be identical with the check authentication code when the firmware is to be confirmed as valid. Once again, it is the operative result that is important: namely, has the remote trusted system confirmed that the response given by the computer system is the correct one?

In one embodiment, equivalent challenges are not issued. Instead, a code representative of the authentication code is sent as a challenge to the remote or local trusted system, and the firmware is determined to be valid or otherwise in dependence upon the resultant check authentication code. In such a system, it is preferred that the challenge code is actually the authentication code itself, although it could be the authentication code which has been modified in some way or which has been passed through some mathematical function. In this arrangement, the check authentication code may simply comprise a Yes/No or Valid/Invalid response which is returned from the trusted system back to the user.

A user wishing to check the validity of the firmware may communicate with the computer system and/or with the trusted system across a local or wide area wired or wireless network, or across the Internet. Communication may be via one or more secure channels and/or via encrypted and preferably signed messages across one or more insecure channels.

Alternatively, the trusted system may be local to the user, and indeed in a preferred embodiment comprises a computer algorithm which is executed locally by the user. The algorithm itself may have been supplied to the user by the trusted third party via some secure channel such as by encrypted e-mail or on physical media.

The user who wishes to validate the firmware could be anybody, but will typically be a purchaser or user of the computer system, or its owner. Where a manufacturer, for example of security systems, has sent out a module to be manufactured by a third party under a sub-contract, the user may be the original manufacturer who may wish to check the integrity of the module that has been manufactured on his behalf. In those circumstances, the original manufacturer may effectively be both the user and the agent controlling the trusted system.

Generally, the trusted system may be under the control of an agent, the manufacturer, or some other trusted third party or independent organisation. As described above, the person or organisation which actually runs the algorithm contained within the trusted system may, but need not be, the agent, manufacturer, trusted third party or independent organisation itself. The algorithms making up the trusted system may actually be operated, locally, by the user, allowing the user to check for himself the validity of a security module without needing to refer, every time, to an outside organisation.

According to a further aspect of the invention, there is provided a method of validating firmware within a computer system, the method comprising:

(a) issuing equivalent challenges to the computer system and to a trusted system;

(b) at the computer system, comprising an authentication code in dependence upon:

(i) a first input comprising the challenge, and

(ii) a second input representative of the firmware to be validated;

(c) at the trusted system, computing a check authentication code;

(d) determining the validity of the firmware by comparing the authentication code and the check authentication code;

the method being characterised in that the firmware is held in persistent memory in compressed form, along with an uncompression routine and additional substantially incompressible data to fill the memory.

According to a further aspect, there is provided a method of validating firmware within a computer system, the method comprising:

(a) issuing a challenge to the computer system;

(b) at the computer system, comprising an authentication code in dependence upon:

(i) a first input comprising the challenge, and

(ii) a second input representative of the firmware to be validated;

(c) supplying a challenge code representative of the authentication code as a challenge to a trusted system;

(d) at the trusted system, computing a check authentication code in dependence upon the said challenge code; and

(e) determining the validity of the firmware in accordance with the check authentication code;

and in which the firmware is held in persistent memory in compressed form, along with an uncompression routine and additional substantially incompressible data to fill the memory.

According to yet a further aspect, there is provided a computer system containing firmware to be validated, the system including authentication means arranged to return an authentication code in dependence upon:

(i) a first input comprising an external challenge, and

(ii) a second input representative of the firmware; the system being characterised in that the firmware is held in persistent memory in compressed form, along with an uncompression routine and additional substantially incompressible data to fill the memory.

The present invention, in its various embodiments, allows a user to be absolutely certain that the firmware within a system has not been changed or subverted without his knowledge, even in respect of secure systems which prevent the user from having any access to the firmware itself.

The invention may be carried into practice in a number of ways and several specific embodiments will now be described, by way of example, with reference to the accompanying drawings, in which:

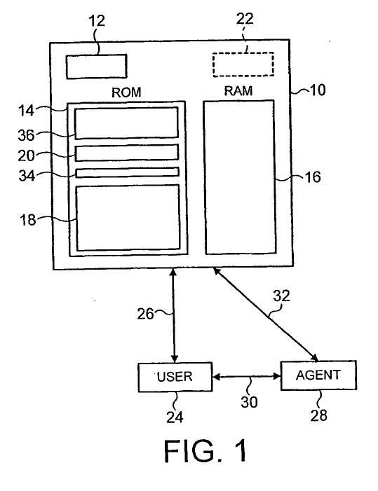

FIG. 1 is a schematic view of a firmware validation system according to an embodiment of the invention;

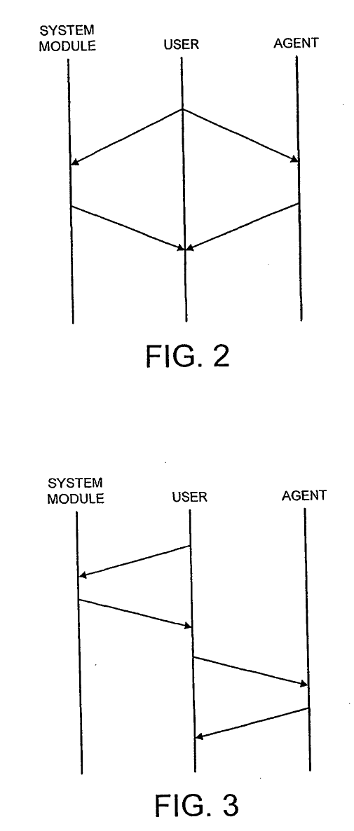

FIGS. 2 and 3 show alternative message flows; and

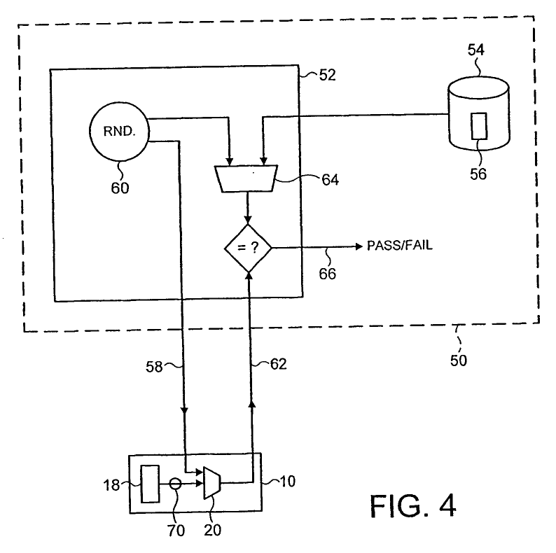

FIG. 4 shows an embodiment in which the trusted system is a software algorithm run by the user.

Turning first to FIG. 1, there is shown a computer system 10 containing the usual processor 12, ROM 14 and RAM 16. The ROM 14 contains firmware 18 to be validated. It will be understood that the ROM could be replaced with any other type of persistent memory technology. A computer system 10 is preferably although not necessarily a secure embedded system or secure module which prevents the software 18 from being extracted, copied or otherwise interfered with. The computer system 10 forms an embodiment of the invention in its own right.

The computer system 10 contains a firmware validation mechanism which may take the form either of a software authentication function 20 or, alternatively, a hardware authentication module 22. In either case, the system makes us of an Message Authentication Code algorithm to return an authentication code in dependence upon:

1. A first input, comprising an external challenge from a user 24, and

2. A second input representative of the firmware 18.

The function 20 or the module 22 may make use of any standard Message Authentication Code (MAC) functionality such as HMAC (Hash MAC) or CBCMAC (Cypher Block Chaining MAC). Any other appropriate algorithm could be used having the following properties:

The output is deterministic for any given set of inputs, knowledge of the inputs allowing the output to be created in a straightforward fashion.

Knowledge of the output alone does not reveal any useful information about the inputs.

Knowledge of the difference between two inputs, or otherwise incomplete knowledge of the inputs, does not provide enough information to determine the difference in the resultant outputs, even if one of the outputs is known.

In order to verify the calculations carried out by the system, the user will refer to a trusted third party or agent 28 who is assumed to have definitive knowledge of the firmware 18 that should be contained within the ROM 14. The agent might be the system manufacturer, an agent of the manufacturer, some trusted independent computing device, or some other trusted third party.

The user 24, wishing to check the validity of the firmware 18, first picks a random challenge number in some large, predefined range and passes that challenge on to the system 10 via some channel 26. The function 20 or the module 22 computes the Message Authentication Code using both the challenge value and the full contents of the firmware 18 within the system, and sends back an authentication code to the user. The user then presents the same (or an equivalent) challenge to the trusted third party or agent 28, via some other channel 30. The agent then computes the same message authentication code using the same challenge, and returns the correct response. The agent may conveniently do this by using an identical algorithm to that used by the computer system 10, ensuring that one of the inputs represents the expected firmware that is meant to be contained within the ROM 14. The user 24 compares the responses, and accepts the firmware 18 as being valid if the two responses are the same.

The message flows are illustrated in FIG. 2. The user presents a challenge to the module and an equivalent (for example an identical) challenge to the agent. Both the module and the agent send back responses, which the user then tests for equivalence.

In a variant of the invention, the user could instead present both the challenge and the response to the agent 28, who would then return a simple Yes/No answer as to the validity of the firmware.

In yet another alternative, it may not be necessary for the user to submit the original challenge to the agent, at all. If the authentication code returned by the system 10 contains enough information on its own for the agent to determine the validity or otherwise of the firmware, a separate copy of the challenge itself may be unnecessary. To take an extremely trivial example, if the authentication code returned by the system 10 were to include, within it, an encrypted version of the original challenge, that code would be the only thing needed by the agent (using appropriate decryption software) to allow it to confirm back to the user whether or not the firmware was valid.

The message flows for this arrangement are illustrated in FIG. 3. The user presents a challenge to the module, and obtains its response. The user then presents a challenge to the agent based upon this response (and possibly also based upon the original challenge). The agent then returns a Pass/Fail result to the user.

Because of the large number of possible challenges available to the user, it would not be feasible for an attacker to replicate the MAC functionality by means of a lookup table or any other function that did not actually require the presence of the correct version of the firmware.

In a typical implementation, the system 10 may be physically remote from the user 24, which is itself physically remote from the agent 28. The communication channels 26,30 may include any convenient communication channels such as a wired or wireless network, the Internet, or point to point connections. Preferably, the channels are secure, but alternatively communication may be carried out by means of encrypted and signed messages. By these means, the user can be confident that the authentication code is coming back from the required computer system 10 to be checked, and that the check authentication code is coming back from the true, trusted agent 28.

A further similar channel 32 may be provided between the agent 28 and the system 10 allowing the agent to check the firmware directly.

In order to prevent the type of attack discussed above in relation to WO-A-0018162, the firmware 18 within the ROM 14 is stored in compressed form, along with a small uncompression program 34. Any remaining part of the ROM is completely filled with random or otherwise substantially incompressible data 36.

Before any part of the firmware is executed, the uncompression program 34 expands that firmware from the ROM 14 into the RAM 16, and the code is executed from there. When a challenge is presented, the Message Authentication Code is computed not on the basis of the firmware alone, but on the entirety of the data (including the random data) contained within the ROM 14. The agent 28 of course computes its code using the correct, known, entirety of the contents of the ROM 14.

As is well known, it is very hard to compress data that has already been compressed, and it is also essentially impossible to compress random information. So long as the uncompression code 34 is small and tightly written, it will be very hard indeed for an attacker to compress the contents of the ROM 14 enough to make room for any alternative version of the code to be inserted, while still keeping a copy of the original. Thus, it will not be possible for the bogus ROM both to alter the function of the firmware and still to return a valid response to any possible challenge.

As an alternative or in addition to compression, the firmware could be encrypted, with the uncompression program 34 being replaced with an appropriate decryption program. Such an approach may, however be less secure since either the decryption key itself has to be stored on the ROM, or the system 100 has to have some other way of getting hold of the decryption key whenever it needs to execute the firmware.

In the embodiment so far described, the agent 28 controls and operates the trusted system (the validation algorithm) to which the user 24 refers. However, it is not essential for the agent/manufacturer/trusted third party/independent organisation actually to run the validation routine, provided that it maintains control of the way that the validation routine operates. In one convenient embodiment, illustrated schematically in FIG. 4, the agent provides a validation routine for the user to run himself whenever he wishes to validate the firmware. A validation routine 52 along with a firmware file 54 containing a copy 56 of the “correct” firmware (i.e. the expected contents of the ROM 14) is supplied on a CD ROM or other physical media, as indicated by the dotted line 50. Alternatively, the programs and data 50 could be supplied to the user via some other secure route such as via encrypted e-mail.

When the hardware security module 10 needs to be verified by the user, the validation routine 52 issues a random challenge 58 from a pseudo-random generator 60. This acts as one input to the MAC or other software authentication function 20 within the module. A second input comes from the firmware 18, plus the other ROM data, as previously described. The output from the software authentication function 20 is returned as a response 62 to the validation routine 52.

As part of the validation routine 52 there is a further MAC or authentication routine 64 corresponding to the routine 20 within the module 10. This takes as one of its inputs the random challenge from the random number generator 60, and as its other input the expected contents 56 of the ROM (which will by definition, include the “authentic” version of the firmware that should be contained within the module 10). The output of the MAC 64 is compared with the response 62, and depending upon their equivalence or otherwise, a Pass/Fail signal or message 66 is generated.

The supplier of the CD 50 to the user will often be the same as the supplier or manufacturer of the security module 10. The manufacturer or supplier may not wish the user, or indeed anybody else, to have access to the plain text of the firmware, and to that end the “authentic” contents 56 on the CD ROM 50 may be supplied in encrypted form, the encryption key being known only to the supplier or trusted third party. A corresponding encryption routine 70, capable of encrypting the actual contents of the ROM 14 to the same key, is contained within the security module 10.

When the user wishes to verify the ROM contents, and thus the firmware, the encrypted authentic contents 56 are supplied to the MAC 64, and the actual contents are encrypted on the fly and supplied to the MAC 20 within the module. As before a Pass/Fail result tells the user whether the contents and thus plain text firmware 18 is valid, but this time without disclosing the contents of it to the user.

In another embodiment, the firmware 18 within the module 10 may itself be encrypted, to the same key as used for the encrypted version of the firmware 56 on the CD, in which case there is no need for the encryption routine 70.

It will be understood that because of the nature of the Message Authentication Code, in none of the above embodiments has any information about the details of the firmware 18 been released to the user, or indeed to anybody else.

1. A firmware validation system comprising:
(a) a computer system containing firmware to be validated, the computer system including authentication means arranged to return an authentication code in dependence upon:
(i) a first input comprising an external challenge, and
(ii) a second input representative of the firmware;
(b) a trusted system including check authentication means arranged to return a check authentication code in response to an external challenge; and
(c) means for issuing equivalent challenges to the computer system and the trusted system, and for determining that the firmware is valid if the resultant authentication code is equivalent to the check authentication code;
the system being characterised in that the firmware is held in persistent memory in compressed form, along with an uncompression routine and additional substantially incompressible date to fill the memory.

2. A firmware validation system comprising:
(a) a computer system containing firmware to be validated, the computer system including authentication means arranged to return an authentication code in dependence upon:
(i) a first input comprising an external challenge, and
(ii) a second input representative of the firmware;
(b) a trusted system including check authentication means arranged to return a check authentication code in response to an external challenge; and
(c) means for supplying a code representative of the authentication code as a challenge to the trusted system, and for determining that the firmware is valid in dependence upon the resultant check authentication code;
and wherein the firmware is held in persistent memory in compressed form, along with an uncompression routine and additional substantially incompressible data to fill the memory.

3. A firmware validation system as claimed in claim 1 in which the authentication means comprises a hardware authentication module.

4. A firmware validation system as claimed in claim 1 in which the authentication means comprises a software function.

5. A firmware validation system as claimed in claim 4 in which the software function and the firmware are held in a common persistent memory.

6. A firmware validation system as claimed in claim 1 in which the computer system is an embedded system.

7. A firmware validation system as claimed in claim 1 in which the computer system is a secure system from which the firmware cannot be extracted or copied.

8. A firmware validation system as claimed in claim 1 in which the computer system is a computer security module for the storage of secure data, for example cryptographic keys.

9. A firmware validation system as claimed in claim 1 in which the second input to the authentication means comprises the firmware itself.

10. A firmware validation system as claimed in claim 1 in which the second input to the authentication means includes but is not limited to the firmware itself.

11. A firmware validation system as claimed in claim 1 in which the additional data comprises random data.

12. A firmware validation system as claimed in claim 1 in which the second input to the authentication means includes the compressed firmware, the uncompression routine and the additional data.

13. A firmware validation system as claimed in claim 1 in which the firmware is held in persistent memory in encrypted form, along with a decryption routine.

14. A firmware validation system as claimed in claim 13 in which the second input to the authentication means includes the encrypted firmware, the decryption routine and the additional data.

15. A firmware validation system as claimed in claim 1 in which a user wishing to check the validity of the firmware communicates with the computer system or the trusted system, or both, across a local or wide area network, or across the internet.

16. A firmware validation system as claimed in claim 15 in which communication is via a secure channel.

17. A firmware validation system as claimed in claim 15 in which communication is sent via encrypted messages across an unsecure channel.

18. A firmware validation system as claimed in claim 1 in which identical challenges are issued to the computer system and to the trusted system.

19. A firmware validation system as claimed in claim 1 in which the means for determining that the firmware is valid is held by a user of the system, and compares the authentication code received back from the computer system and the check authentication code received back from the trusted system.

20. A firmware validation system as claimed in claim 1 in which the means for determining that the firmware is valid is part of the trusted system.

21. A firmware validation system as claimed in claim 2 in which the trusted system sends a Yes/No response to a user of the system in dependence upon the result of its determination.

22. A method of validating firmware within a computer system, the method comprising:
(a) issuing equivalent challenges to the computer system and to a trusted system;
(b) at the computer system, computing an authentication code in dependence upon:
(i) a first input comprising the challenge, and
(ii) a second input representative of the firmware to be validated;
(c) at the trusted system, computing a check authentication code; and
(d) determining the validity of the firmware by comparing the authentication code and the check authentication code;
the method being characterised in that the firmware is held in persistent memory in compressed form, along with an uncompression routine and additional substantially incompressible data to fill the memory.

23. A method of validating firmware within a computer system as claimed in claim 24 in which the check authentication code is computed in dependence upon:
(i) a third input comprising the challenge, and
(ii) a fourth input representative of a correct version of the firmware.

24. A method of validating firmware within a computer system, the method comprising:
(a) issuing a challenge to the computer system;
(b) at the computer system, comprising an authentication code in dependence upon:
(i) a first input comprising the challenge, and
(ii) a second input representative of the firmware to be validated;
(c) supplying a challenge code representative of the authentication code as a challenge to a trusted system;
(d) at the trusted system, computing a check authentication code in dependence upon the said challenge code; and
(e) determining the validity of the firmware in accordance with the check authentication code;
and in which the firmware is held in persistent memory in compressed form, along with an uncompression routine and additional substantially incompressible data to fill the memory.

25. A computer system containing firmware to be validated, the system including authentication means arranged to return an authentication code in dependence upon:
(i) a first input comprising an external challenge, and
(ii) a second input representative of the firmware;
the system being characterised in that the firmware is held in persistent memory in compressed form, along with an uncompression routine and additional substantially incompressible data to fill the memory.

26. A computer system as claimed in claim 25 in which the authentication means comprises a hardware authentication module.

27. A computer system as claimed in claim 25 in which the authentication means comprises a software function.

28. A computer system as claimed in claim 27 in which the software function and the firmware are held in a common persistent memory.

29. A computer system as claimed in claim 25 comprising an embedded system.

30. A computer system as claimed in claim 25 comprising a secure system from which the firmware cannot be extracted or copied.

31. A computer system as claimed in claim 25 comprising a computer security module for the storage of secure data, for example cryptographic keys.

32. A computer system as claimed in claim 25 in which the second input to the authentication means comprises the firmware itself.

33. A computer system as claimed in claim 25 in which the second input to the authentication means includes but is not limited to the firmware itself.

34. A computer system as claimed in claim 25 in which the additional data comprises random data.

35. A computer system as claimed in claim 25 in which the second input to the authentication means includes the compressed firmware, the uncompression routine and the additional data.

36. A computer system as claimed in claim 25 in which the firmware is held in persistent memory in encrypted form, along with a decryption routine.

37. A computer system as claimed in claim 36 in which the second input to the authentication means includes the encrypted firmware, the decryption routine and the additional data.

38. A firmware validation system as claimed in claim 1 in which the trusted system comprises a validation algorithm which has been supplied via a secure route from a trusted third party to a user of the firmware validation system.

39. A firmware validation system as claimed in claim 38 in which the trusted system includes a secure copy of an authentic version of the firmware to be validated.

40. A firmware validation system as claimed in claim 39 in which the secure copy is encrypted.

41. A firmware validation system as claimed in claim 40 in which the secure copy is encrypted to a same encryption key as the firmware to be validated.

42. A firmware validation system as claimed in claim 40 in which the secure copy is encrypted to an encryption key, and in which the authentication means includes means for generating the second input by encrypting the firmware to the said key.

43. A method of validating firmware within a computer system as claimed in claim 22 in which the trusted system comprises a computer algorithm which is operated by a user wishing to validate the firmware.

44. A method of validating firmware within a computer system as claimed in claim 43 including the step of supplying the computer algorithm to the user, from a trusted third party, via a secure route.

45. A method of validating firmware within a computer system as claimed in claim 44 including the step of supplying the user with an authentic copy of the firmware via a secure route.

46. A method of validating firmware within a computer system as claimed in claim 44 including the step of supplying the user with an encrypted copy of an authentic version of the firmware via a secure route.

47. A method of validating firmware within a computer system as claimed in claim 46 including calculating the second input by encrypting the firmware to be validated to the same key as that used to encrypt the authentic version of the firmware.

48. A method of validating firmware within a computer system as claimed in claim 47 including calculating the check authentication code in dependence upon:
(i) a third input comprising the challenge, and
(ii) a fourth input comprising the said encrypted copy of the firmware.
